(19) United States
(12) Patent Application Publication
(10) Pub. No.: US 2026/0349108 A1
(43) Pub. Date: Nov. 5, 2026

(54) Radar Sensing Mode Selection in a Wireless Communication Device

(71) Applicant: Telefonaktiebolaget LM Ericsson (publ), Stockholm (SE)

(72) Inventors: Gang Zou, Lund (SE); Fredrik Dahlgren, Lund (SE); Henrik Sjöland, Lund (SE); Magnus Sandgren, Staffanstorp (SE); Magnus Olsson, Klagshamn (SE); Ashkan Kalantari, Malmö (SE); Andres Reial, Höllviken (SE); Rickard Ljung, Helsingborg (SE)

(21) Appl. No.: 19/116,330

(22) PCT Filed: Oct. 3, 2022
(86) PCT No.: PCT/EP2022/077437

§ 371 Date: Mar. 27, 2025

(51) Int. Cl. G01S 13/90; G01S 7/00; G01S 13/86

(52) U.S. Cl. CPC G01S 13/9064; G01S 7/006; G01S 13/867

(57) ABSTRACT

According to techniques disclosed herein, a wireless communication device (10) controls how it performs radar acquisition according to its evaluation of one or more conditions, including a motion condition. For example, the wireless communication device (10) responds to a request for radar sensing by performing Synthetic Aperture Radar (SAR) sensing in dependence at least on verifying that there is ongoing relative motion between the device and a proximate object, and otherwise performs non-SAR sensing. Among the various advantages provided by such operation are the intelligent automation of the radar mode used by the device (10), based on then existing circumstances.

### TECHNICAL FIELD

Methods and apparatuses herein embody techniques whereby a wireless communication device evaluates one or more conditions and performs radar sensing using a radar sensing mode that depends upon the evaluation, with modes including Synthetic Aperture Radar (SAR) sensing and non-SAR sensing.

### BACKGROUND

Mobile devices increasingly integrate radar capabilities, for detecting local obstructions, scanning nearby objects, or employing other sensing of the proximate physical surroundings of the device. For example, with communication signals moving into the GHz ranges, opportunities exist for at least partial reuse of the communications hardware in a wireless communication device for radar sensing. For example, at least portions of a Fifth Generation (5G) modem used by a device for communicating with a 5G Radio Access Network (RAN) may be time multiplexed for communications-signal processing and radar sensing.

However, a typical wireless communication device operates with battery power, which complicates implementation of radar sensing techniques. For example, beyond how often the device performs radar sensing, which may be a function of conditions or third-party applications executing on the device, the radar sensing mode affects battery life. Regarding modes, Synthetic Aperture Radar (SAR) sensing offers higher resolution than non-SAR sensing, at the expense of higher power consumption and greater consumption of processing and storage resources onboard the device.

Existing integrations of radar sensing in wireless communication devices lack intelligent radar control, such as intelligent decision making with respect to radar mode control, based on then existing circumstances.

### SUMMARY

According to techniques disclosed herein, a wireless communication device controls how it performs radar acquisition according to its evaluation of one or more conditions, including a motion condition. For example, the wireless communication device responds to a request for radar sensing by performing Synthetic Aperture Radar (SAR) sensing in dependence at least on verifying that there is ongoing relative motion between the device and a proximate object, and otherwise performs non-SAR sensing. Among the various advantages provided by such operation are the intelligent automation of the radar mode used by the device, based on then existing circumstances.

One embodiment comprises a method of operation by a wireless communication device, where the method includes receiving a request for radar sensing and, responsive to the request, evaluating whether one or more conditions necessary for performing SAR sensing are satisfied. The one or more conditions include at least a motion condition. Responsive to the one or more conditions being satisfied, the method includes performing SAR sensing with respect to a physical environment containing the wireless communication device and correspondingly obtaining SAR sensing data and providing the SAR sensing data responsive to the request.

Another embodiment comprises a wireless communication device. The device includes radar circuitry configured for emission of radar signals and detection of corresponding reflection signals. Processing circuitry included in the device is configured to receive a request for radar sensing and, responsive to the request, evaluate whether one or more conditions necessary for performing SAR sensing are satisfied, the one or more conditions including at least a motion condition. Responsive to the one or more conditions being satisfied, the processing circuitry performs SAR sensing with respect to a physical environment containing the wireless communication device and correspondingly obtains SAR sensing data and provides the SAR sensing data responsive to the request.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication device according to an example embodiment.

FIG. 2 is a block diagram of an Operating System (OS) environment and respective functionality implemented via processing circuitry of a wireless communication device according to an example embodiment.

FIG. 3 is a block diagram illustrating non-SAR and SAR sensing data.

FIG. 4 is a block diagram of proximate object detection via radar sensing by a wireless communication device.

FIG. 5 is a plot of radar signal emission and corresponding return reflections, in an example radar event.

FIGS. 6A, 6B, and 6C are block diagrams illustrating relative motion between a wireless communication device and a proximate object, for SAR sensing by a wireless communication device.

FIGS. 7 and 8 are logic flow diagrams corresponding to a method of operation by a wireless communication device for controlling radar sensing according to an example embodiment.

FIG. 9 is a block diagram depicting an example scenario for SAR sensing by a wireless communication device.

FIG. 10 is a logic flow diagram corresponding to another method of operation by a wireless communication device for controlling radar sensing according to an example embodiment.

### DETAILED DESCRIPTION

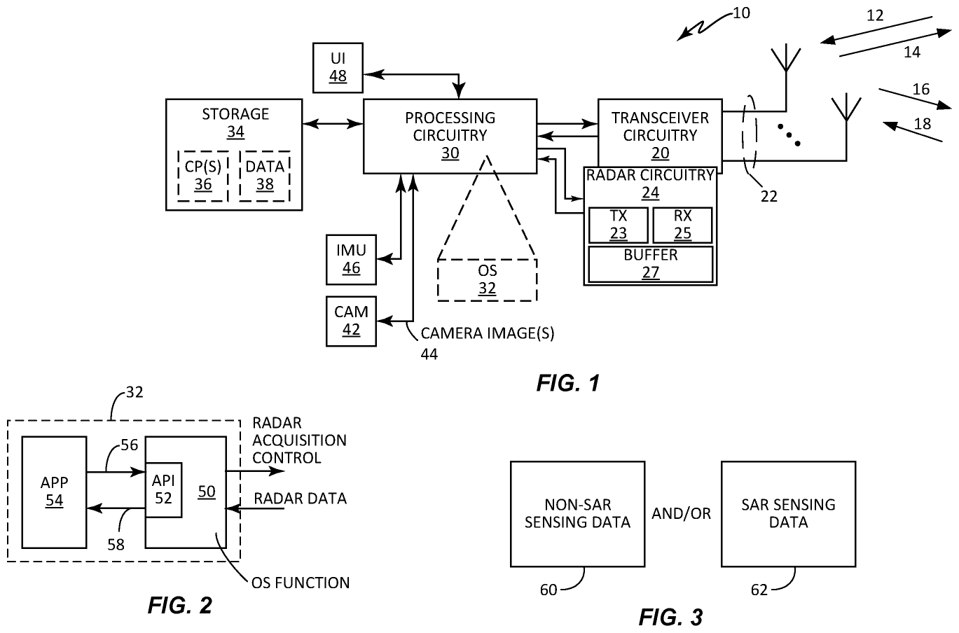

FIG. 1 illustrates a wireless communication device 10 (“device 10”) according to an example embodiment. In one or more examples, the device 10 is configured for wirelessly communicating with access nodes in a wireless communication network, such as a cellular radio network operating according to Third Generation Partnership Project (3GPP) specifications. As a more specific example, the device 10 is configured for operation using a 5G New Radio (NR) air interface involving downlink communication signals 12 and uplink communication signals 14 that are in a GHz range.

The device 10 is configured to perform radar sensing. Radar sensing involves the emission of radar signals 16 and the corresponding detection of reflected signals 18 returned by one or more objects in a surrounding physical environment that contains the device 10, based on such objects scattering the emitted radar signals 16.

An example arrangement of the device 10 includes transceiver circuitry 20 that includes a radio transmitter and a radio receiver for the transmission and reception of communication signals 12 and 14 via one or more antennas 22. The antenna(s) 22 comprise, for example, multiple antenna elements implemented as one or more antenna arrays, with each array element having respective transmit and/or receive signal chains comprising, e.g., filters, amplifiers, etc. Such arrangements provide for one or both transmission beamforming and reception beamforming.

The transceiver circuitry 20 in one or more embodiments comprises mixed-signal integrated circuitry handling both the analog radio signals 12 and 14 and at least a portion of the digital-domain processing applied to received signals 12 after demodulation and digitization and applied to transmit signals in the digital domain, before modulation and conversion to the analog domain for transmission. In one or more other embodiments, the transceiver circuitry 20 may be understood as analog domain front-end circuitry, with baseband processing handled elsewhere in the device 10.

In either case, the device 10 includes radar circuitry 24, including a radar transmitter 23, a radar receiver 25, and, in one or more embodiments, buffer circuitry 27 for buffering received reflection signals. One or more of these radar elements may be common with the communications-related elements. For example, all or a portion of the radar transmitter 23 may be used for transmission of communication signals. As another example, the antennas 22 in one or more embodiments are shared for communications and radar sensing. Moreover, the buffer circuitry 27 may be used for reflection-signal samples at times when it is not used for holding samples of received communication signals 12. Similarly, the radar receiver 25 may be the same receiver as used for the reception of communication signals 12, or it at least may use the same front-end received signal chains used for receiving communication signals 12. The radar elements may in some cases be controlled by a wireless communication system, e.g., for allocation of time and frequency resources of radar signals.

The radar transmitter 23 in one or more embodiments is configured for modal operation, wherein radar sensing is performed on a selective basis, either as Synthetic Aperture Radar (SAR) sensing or as non-SAR sensing. Here, SAR sensing refers to the emission of multiple radar pulses and the corresponding collection of sensing results—reflection data—for each pulse, and subsequent processing of the sensing results obtained over the multiple radar pulses, to obtain SAR sensing data. Non-SAR sensing refers to sensing results not involving the synthesis of sensing data across multiple radar emissions, such as single-pulse sensing, wherein the device 10 emits a single radar pulse and “listens” for reflections over a single corresponding detection window. Single-pulse sensing may be referred to as “snapshot” sensing and although the device 10 may perform multiple snapshots in succession, the sensing data for each snapshot is handled individually rather than being used to synthesize an overall sensing result.

SAR sensing offers several advantages including providing higher resolution sensing, as compared to that provided by non-SAR sensing. Higher resolution sensing via SAR comes with higher costs, too, as compared to non-SAR sensing, in terms of power consumption, the time needed for the sensing, and the consumption of storage and computing resources onboard the device 10. Thus, while the proposition that circumstances might sometimes favor non-SAR sensing and sometimes favor SAR sensing is straightforward, realization of a device 10 with intelligent, autonomous (automatic) selection of the radar sensing mode involves subtle considerations.

Before delving into example techniques for autonomous selection of the radar sensing mode used by the device 10, cataloging the remaining circuitry and corresponding functional features of the device 10 as depicted in FIG. 1 is helpful. Processing circuitry 30 included in the device 10 comprises one or more types of processing circuits, such as fixed circuitry or programmatically configured circuitry or a mix of both. In embodiments of the transceiver circuitry 20 wherein the transceiver circuitry 20 omits baseband processing, the processing circuitry 30 includes one or more types of circuitry dedicated to performing baseband processing for outgoing communication signals 14 and incoming communication signals 12. Thus, the transceiver circuitry 20 and associated portions of the processing circuitry 30 operate as a radio modem in support of the RAN-based communications supported by the device 10. In other embodiments, the transceiver circuity 20 includes baseband processing and operates as a radio modem that receives information for transmission from the processing circuitry 30 as outgoing communication signals 14 and outputs information extracted from received communication signals 12.

Similarly, with respect to radar sensing, the digital-domain processing, including evaluation of radar sensing data, is performed by the processing circuitry 30 in one or more embodiments. Moreover, the processing circuitry 30 in one or more embodiments provides the intelligent decision-making that determines the radar mode, and it provides control signaling to the radar circuitry 24 for initiation and control of radar sensing. That is, for any given radar sensing event, the processing circuitry 30 triggers the radar circuitry 24 and controls it, according to the selected radar mode.

In at least one embodiment, the processing circuitry 30 includes one or more microprocessors, DSPs, Field Programmable Gate Arrays (FPGAs), Application Specific Integrated Circuits (ASICs), or Systems-on-a-Chip (SoCs) that implement the functionality described herein, based on the execution of computer program instructions. In other words, one or more general digital processors are specially adapted to operate as all or a portion of the processing circuitry 30 described herein, based on the execution of stored computer programs. In at least one such example, the processing circuitry 30 executes Operating-System (OS) instructions causing it to implement an OS 32 that provides a run-time execution environment for one or more software applications installed on the device 10.

Correspondingly, in one or more embodiments, the device 10 includes storage 34 that stores one or more computer programs (“CP(s)”) 36 and data 38, and the data 38 may include pre-provisioned data for configuration of certain aspects of operation by the device 10 and/or data generated during live operation of the device 10. The storage 34 comprises one or more types of computer-readable media, such as a mix of volatile memory for program execution and non-volatile memory for longer-term storage. As a non-limiting example, types of storage include any one or more of RAM, NVRAM, FLASH, Solid State Disk (SSD), and EEPROM.

Other elements of the device 10 in the example depiction include a camera 42 for acquiring camera images 44, where the camera field of view encompasses at least a portion of the surrounding physical environment. Further, an Inertial Measurement Unit (IMU) 46 provides motion sensing along one or more axes, such as for detecting translational motion and/or rotational motion of the device 10 within physical space. Still further, the device 10 includes a user interface (UI) 48, such as a touchscreen and/or a microphone and speaker, for interacting with a user of the device 10. Of course, whether the device includes such elements and the features implemented via such elements depends on the intended use of the device 10.

With the above example details in mind, a device 10 according to one or more embodiments includes radar circuitry 24 configured for emission of radar signals 16 and detection of corresponding reflection signals 18, and processing circuitry 30. The processing circuitry 30 is configured to: (a) receive a request for radar sensing; (b) responsive to the request, evaluate whether one or more conditions necessary for performing Synthetic Aperture Radar (SAR) sensing are satisfied, the one or more conditions including at least a motion condition; (c) responsive to the one or more conditions being satisfied, perform SAR sensing with respect to a physical environment containing the device 10 and correspondingly obtain SAR sensing data; and (d) provide the SAR sensing data responsive to the request.

The request may come from an external requestor and be received via incoming communication signals 12 and the SAR sensing data may be returned to the external requestor via outgoing communication signals 14. In other embodiments, or in other instances of radar sensing, the request may originate locally, e.g., an application running within the OS 32 implemented or instantiated by the processing circuitry 30 based on its execution of OS program code held in the storage 34. FIG. 2 depicts a corresponding example.

According to FIG. 2, the processing circuitry 30 provides an OS function 50 that is configured to receive the request, labeled “request 56” in the diagram, from an application 54 executing in an OS 32 implemented by the processing circuitry 30. The request 56 is received via an Application Program Interface (API) 52 provided by the OS 32, and the OS function 50 is configured to control the radar circuitry 24 to obtain the SAR sensing data and output the SAR sensing data to the application 54 via the API 52. The reference number “58” in FIG. 2 depicts return signaling to the requestor, which may be SAR or non-SAR sensing data and/or indications related to fulfillment or non-fulfillment of the request 56.

With quick reference to FIG. 3, any given radar sensing event involves the device 10 performing radar sensing and, depending on the mode control described herein, the device 10 may perform non-SAR sensing to acquire non-SAR sensing data 60—single-shot radar sensing data—or may perform SAR sensing to acquire SAR sensing data 62—synthesized data computed over multiple radar pulses and corresponding reflections. In some circumstances, responding to a request 56 may include the device 10 performing both non-SAR and SAR sensing.

The processing circuitry 30 in one or more embodiments is configured to respond to any one or more of the conditions not being satisfied by performing non-SAR sensing in response to the request 56, and correspondingly obtaining non-SAR sensing data 60 and providing the non-SAR sensing data 60 responsive to the request 56. In the same or other embodiments, the processing circuitry 30 is configured to send an indication towards a requestor that originated the request 56, responsive to any one of the one or more conditions not being satisfied. In other words, responsive to determining that the condition(s) for SAR sensing are not satisfied, the device 10 may perform non-SAR sensing and/or provide an indication to the requestor that autonomous SAR sensing is not available. In one example of the latter case, the requestor may cause a prompt to be output on the UI 48 of the device 10, prompting the user of the device 10 to sweep the device 10 in a scanning motion, to support SAR sensing.

In addition to the motion condition, in at least one embodiment, the one or more conditions include a proximate object condition. Here, the processing circuitry 30 is configured to determine whether the proximate object condition is satisfied based on at least one of: acquiring one or more images 44 from a camera 42 of the device 10 and determining whether the one or more images 44 indicate the presence of a proximate object. Additionally, or alternatively, the processing circuitry 30 is operative to acquire non-SAR sensing data 60 and determine whether the non-SAR sensing data 60 indicates the presence of a proximate object.

Determining whether the motion condition is satisfied is based on, for example, the processing circuitry 30 being configured to acquire at successive times, non-SAR sensing data 60 or camera images 44 and determine whether a difference in estimated positions of a proximate object detected over the successively acquired non-SAR sensing data 60 or camera images 44 indicate relative movement between the object and the device 10. For cases where the successively acquired non-SAR sensing data 60 or camera images 44 indicate relative movement but where an IMU 46 of the device 10 indicates no translational or rotational motion of the device 10, the processing circuitry 30 is configured to perform the SAR sensing as an Inverse SAR (ISAR) acquisition. That is, ISAR acquisition differs from SAR acquisition in that ISAR relies on movement of the object, while SAR relies on movement of the device 10. In both SAR and ISAR acquisition, however, the overall sensing result involves synthesis of reflection data across multiple radar-signal emissions. For cases where the successively acquired non-SAR sensing data 60 or camera images 44 indicate relative movement and where an IMU 46 of the device 10 indicates translational or rotational motion of the device 10, the processing circuitry 30 is configured to perform the SAR sensing as a SAR acquisition.

In at least one embodiment, the one or more conditions include a request condition, and the processing circuitry 30 is configured to determine whether the request condition is satisfied by determining whether the request 56 requests radar sensing at a resolution higher than that provided by non-SAR sensing. That is, in some cases, the requestor may use the request to specify sensing requirements, such as accuracy or resolution, and the processing circuitry 30 evaluates such requirements to determine whether they are met by non-SAR sensing. If non-SAR sensing meets the request requirements, the processing circuitry 30 in one or more embodiments uses the radar circuitry 24 to carry out non-SAR sensing and returns non-SAR sensing data 60.

Other conditions evaluated in one or more embodiments for intelligently deciding whether to respond to a request 56 via SAR sensing, non-SAR sensing, or some other alternative action—e.g., a return failure or other indication, include any one or more of: battery level of the device and communication needs of the device 10. The latter condition applies in instances where radar sensing and communications require multiplexed sharing of antennas or device circuitry.

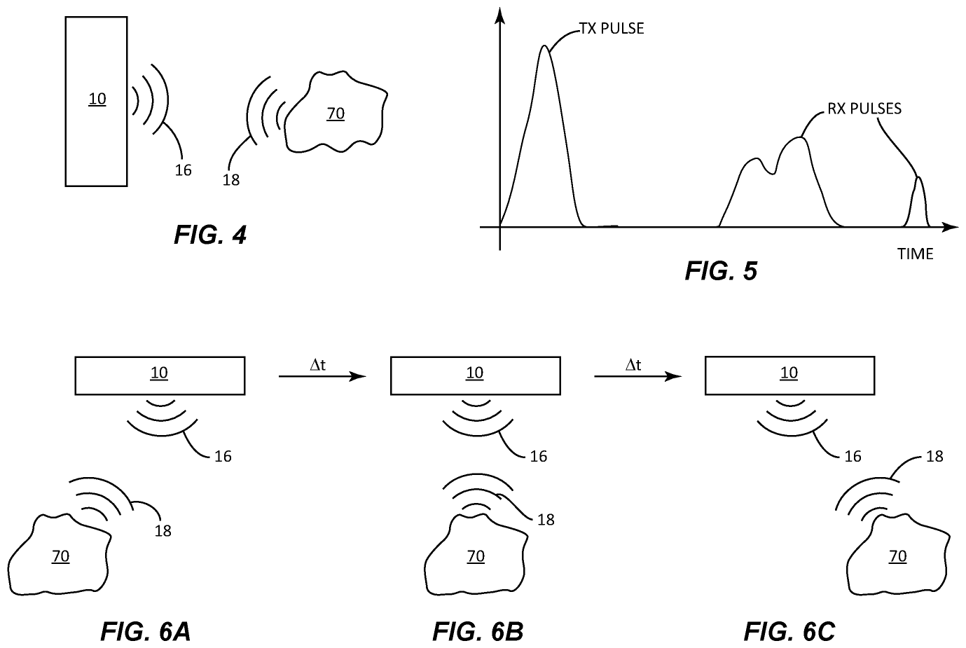

FIG. 4 illustrates an example radar event, where the device 10 emits a radar signal 16 and a proximate object 70 scatters the radar signal 16, resulting in return reflections, which are referred to as reflection signals 18. Not all reflections reach the device 10, or have sufficient signal strength for detection; thus, references to reflection signals 18 denote the signals received and detected by the device 10.

FIG. 5 illustrates an example power delay profile in which the device 10 emits a radar signal 16 as a transmission (TX) pulse and later receives one or more return (RX) pulses. Here, the RX pulses are reflection signals 18 captured by the device 10 and they may be held as a stream of digital sample values held in a buffer circuit. The TX pulse defines time to, for example, so the temporal distance between the TX pulse and each of the RX pulses relates to object distance. With a known sample rate for capturing reflection signals 18, the number of sample positions between a TX pulse and a respective RX pulse indicates signal flight time, which translates into distance. In SAR processing, the difference in carrier phase between transmit and receive pulses also provides distance information. Pulses may overlap or otherwise have irregular shapes and the processing circuitry 30 may be configured to filter RX pulses or otherwise process them to accurately discriminate between RX pulses and locate pulse starts, centers, etc.

FIGS. 6A, 6B, and 6C depict an example scenario satisfying a motion condition, wherein there is relative movement between the device 10 and an object 70, with the respective figures depicting the emission of a radar signal 16 at successive times, with the device 10 detecting reflection signals 18 at each such emission. With each emission producing reflection data and with the reflection data for the respective emissions representing different relative positions of the device 10 with respect to the object 70, synthesis of the reflection data over the multiple sets of reflection data yields SAR sensing data 62.

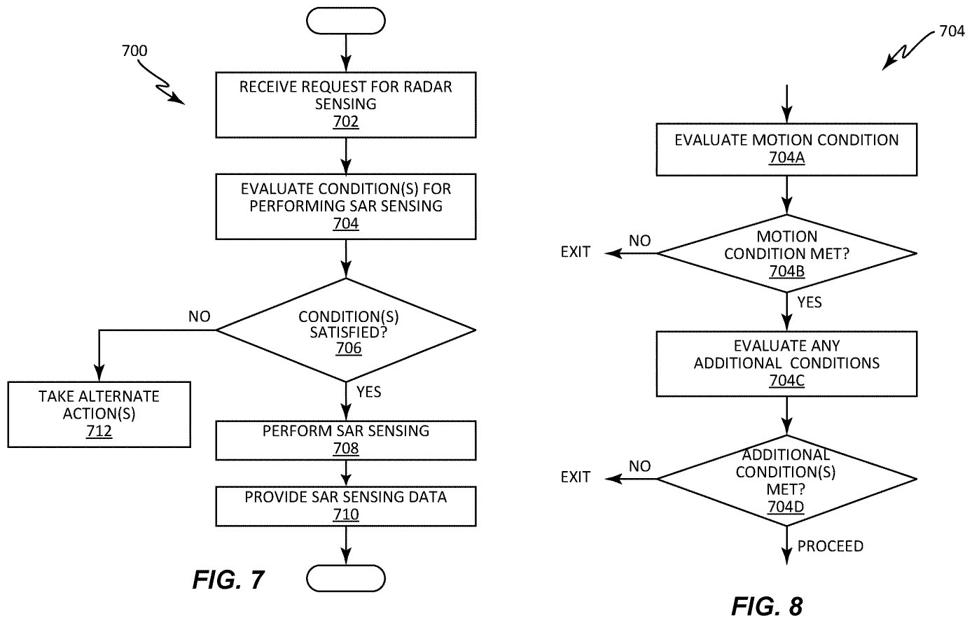

FIG. 7 illustrates a method 700 of operation by a wireless communication device 10, e.g., according to the programmatic configuration of one or more microprocessors or other digital processing circuitry. The method 700 includes: receiving (Block 702) a request 56 for radar sensing; responsive to the request 56, evaluating (704) whether one or more conditions necessary for performing SAR sensing are satisfied, the one or more conditions including at least a motion condition; responsive to the one or more conditions being satisfied (YES from Block 706), performing (708) SAR sensing with respect to a physical environment containing the device 10 and correspondingly obtaining SAR sensing data 62; and providing (Block 710) the SAR sensing data 62 responsive to the request 56. If the one or more conditions are not satisfied (NO from 706), the device 10 takes one or more alternate actions (Block 712), such as returning an indication to the requestor that SAR sensing is not available under the current conditions or returning non-SAR sensing data.

As noted, the request 56 may be received via communication signals 12 incoming to the device 10 or may be received from an application 54 executing in an OS 32 provided by the device 10, such that providing the SAR sensing data means providing the SAR sensing data to the application 54. An API 52 provided by the OS 32 may provide for exchanging requests and sensing data. Among the many advantages of such an arrangement, applications running on a device 10 need not specify SAR sensing or non-SAR sensing and instead may indicate sensing requirements, such as resolution, and rely on intelligence built into the device 10—e.g., an OS function 50 as shown in FIG. 2, to determine the radar sensing mode used. That is, in response to determining that the request 56 involves a sensing resolution not met by non-SAR sensing, the device 10 “automatically” uses SAR sensing to meet the request. Or, more particularly, the device 10 advantageously evaluates one or more conditions bearing on whether the condition(s) for autonomous performance of SAR sensing are satisfied and performs SAR sensing responsive to determining that the condition(s) are satisfied.

The method 700 may, as a baseline evaluation, include the device 10 determining whether there is ongoing relative motion between the device 10 and a proximate object 70, with such motion being a prerequisite for SAR sensing. The method 700 may further include determining whether one or more other conditions are satisfied, such as whether the request specifies sensing requirements that cannot be met using non-SAR sensing, whether there is a sufficient State-of-Charge (SoC) on the battery that provides operating power to the device 10, whether SAR sensing will interfere with, or is estimated as interfering with, communication activities, etc. FIG. 8 provides an expanded view of the condition evaluation, illustrating Steps 704A, 704B, 704C, and 704D, which include evaluation of the motion condition and any further conditions, where processing proceeds with SAR sensing responsive to satisfaction of all conditions, or exits for alternate actions responsive to non-satisfaction of one or more of the conditions. These other actions include any one or more of: sending an indication that SAR sensing is not available under the current conditions or sending non-SAR sensing data 60 rather than SAR sensing data 62.

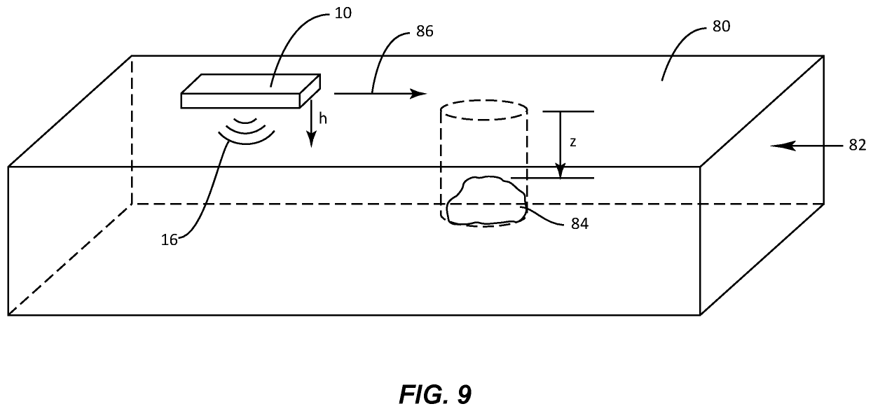

FIG. 9 illustrates an example “hidden object” scenario where SAR sensing yields results not achievable with non-SAR sensing. A wall 80 or other flat surface covers an underlying void or space 82 that contains an object 84 some distance z below the surface 80. Performing SAR sensing as the device 10 translates along a path 86 that runs along the surface 80 yields SAR sensing data 62 that reveals the presence of the hidden object 84 if the path 86 traverses across the surface above the hidden object 84.

Broadly, the foregoing details can be understood as example methods and apparatus, wherein a wireless communication device or other mobile device achieves more efficient radar performance, where the selectable radar modes include non-SAR sensing and SAR sensing, where SAR sensing selectably comprises performing a SAR acquisition or an ISAR acquisition. In this context, this disclosure proposes an advantageous method for radar operation mode adaptation in a mobile device that includes a radar unit supporting mode selection. The method includes determining a first radar mode from two or more candidate modes based on one or more criteria—one or more conditions—and configuring the radar unit to operate according to the first radar mode. Such operations may include any one or more of: determining operation parameters for the first radar mode and configuring the first radar mode to operate according to such parameters; when in SAR mode, indicating a preferred device movement pattern to the user; using a signal/trigger from an application running on the device or a condition configured by such application; detecting a predefined device movement pattern using device internal sensors; detecting a predefined object proximity or object movement pattern using radar output from the current radar mode, camera, or sensing using communication RAT.

Other conditions that may be used by the device to control the radar mode selected or to configure the radar sensing parameters include: a status change in the device, the level of allocated resources for radar signal transmissions, or the determined level of energy consumption needed to meet requirements of the radar application. Further, in at least one embodiment, the device uses an included user interface to visualize the selected radar operation mode.

One option is to only use SAR radar to the extent needed for a certain scenario. A device 10 may also adapt its radar output power, frequency range, duration, or active duty cycle, etc., to tailor radar performance to the applicable requirements. The device 10 may provide device movement guidelines to the user e.g., on the screen or via vibration feedback to guide the user for optimal scanning trajectory. In one embodiment, the application may provide such parameter and guidance information to configure the radar sensing via an application-layer/lower-layer interface (API) provided in the device 10. Again, see the example OS API 52 depicted in FIG. 2, providing access to an OS function 50 that controls radar sensing based on requirements specified by an application 54 and based on evaluating one or more conditions that bear on the ability or appropriateness of the device 10 performing SAR sensing versus non-SAR sensing.

In one aspect, appropriate scanning trajectory can be selected to reduce power consumption. In one example, if there is an existing SAR image—existing SAR sensing data 62—from previous scanning by the device 10 or otherwise provided to the device 10, the device 10 may only run a single-shot mode radar—non-SAR sensing—to sanity check the non-SAR sensing data 60 against the prior SAR sensing data 62 and perform new SAR sensing only when deviations are detected.

Another option, prior to SAR scanning, the radar in the device 10 may perform a test single shot (e.g., with its beam perpendicular to the scanning surface), and analyze the corresponding backscattered radar signal. If the analysis shows the scanning surface is most likely a metal surface, the device may inform the user that the SAR scanning is on a metal surface with no possibility of performing sub-surface scans. Correspondingly, the device 10 may cancel the SAR scanning. As a result, from switching radar modes, a user interface of the device 10 may change its behavior for an end user of the device 10. In one example an indicator of the currently used radar mode may be visible in a user interface.

The device 10 may forego SAR sensing or revert from SAR sensing to non-SAR sensing responsive to any one or more of: device battery level dropping below a threshold, no proximate objects detected, required communication or computational resources in radar device are no longer available or SAR sensing is otherwise infeasible. Regarding communication operations, the device 10 may stop or not enter a SAR sensing mode when a communications session starts (e.g., the device enters connected mode from idle mode), or responsive to the device estimating that a data session is imminent. For example, the device 10 may be operating on a periodic wake-up schedule for communications or may be using periodically scheduled communication resources.

Furthermore, multiple devices 10 intend SAR operation with radar radio resource allocated by a wireless communication network, e.g., a cellular network. When the allocated radio resources are not enough to support SAR sensing by all devices 10, one or more of the devices 10 may request specific resource allocations for SAR sensing. Here, “resources” refers to a frequency or frequency range, and may refer to additional resource dimensions, such as times, codes, etc., which may be used to provide for reuse of the same frequencies by different devices 10.

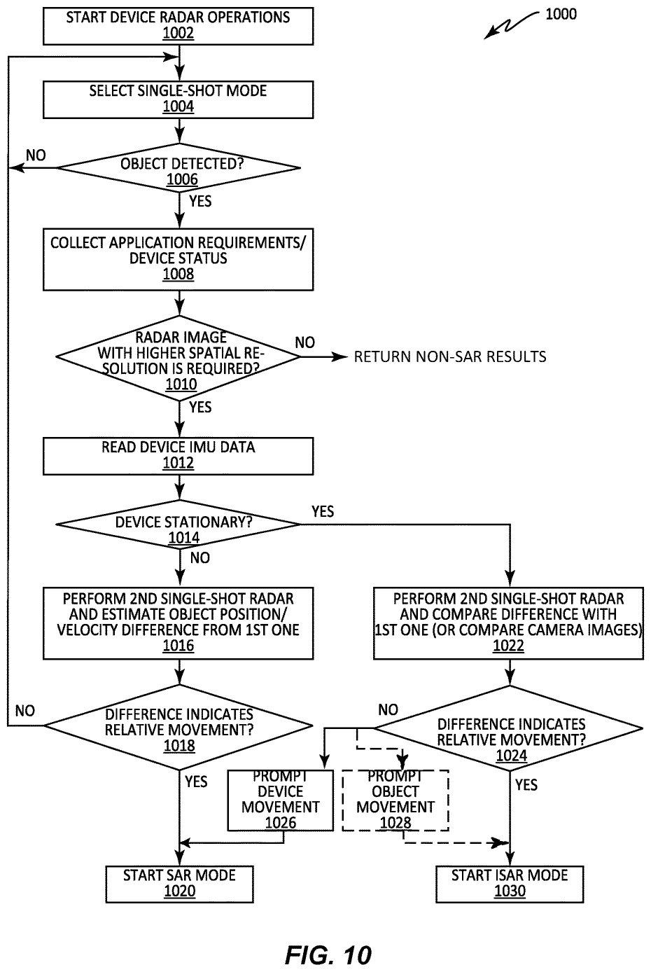

FIG. 10 illustrates a method 1000 of operation by a device 10, where the method 1000 considers at least some of the above aspects of intelligent, autonomous control of the radar sensing mode used by a device 10.

The method 1000 begins with starting radar operations (Block 1002) and selecting (Block 1004) a single-shot radar mode. Single-shot refers to the emission of a single radar signal 16—one TX pulse—and the windowed reception of corresponding reflection signals 18—RX pulses. As such, single-shot sensing is non-SAR sensing.

Processing continues with evaluating (Block 1006) whether the single-shot sensing results indicate the presence of a proximate object. If not (NO from 1006), processing returns to repeat the single-shot sensing. Responsive to the single-shot sensing results indicating a proximate object (YES from 1006), processing continues with collecting (Block 1008) application requirements—i.e., radar sensing requirements—and device status, which can be understood as the current condition(s) of the device 10 that bear on the possibility or feasibility of SAR sensing.

The device 10 then evaluates whether the requirements specified by the application require radar resolution higher than that provided by the single-shot sensing. If not, (NO from Block 1010), processing continues with terminating radar acquisition and returning the single-shot (non-SAR) sensing results to the application.

If resolution better than that afforded by non-SAR sensing is required (YES from Block 1010), processing continues with the device 10 reading (Block 1012) IMU data. If the IMU data indicates that the device is moving (NO from Block 1014), the device 10 performs another single-shot acquisition and estimates the differences in estimated object position and velocity. That is, the device 10 compares the position of the same object detected across two or more non-SAR sensing events to estimate object velocity. If the differences evidence relative movement between the device 10 and the object (YES from Block 1018), the device 10 starts the SAR sensing mode and otherwise (NO from Block 1018) returns to single-shot acquisition operations. Note that rather than using data from successive single-shot radar acquisitions to estimate movement, the device 10 may use successive camera images 44.

If the IMU data indicates that the device 10 is stationary (YES from Block 1014), the device 10 performs (Block 1022) one or more further single-shot acquisitions, or acquires one or more camera images, and compares the difference observed in the successive data to determine whether the object is moving relative to the device 10. If so (YES from Block 1024), the device 10 performs SAR sensing via an ISAR acquisition (Block 1030). If not (NO from Block 1024), the device 10 may undertake actions to prompt movement of the device 10 (Block 1026) or movement of the object (1028). For example, the device 10 outputs a prompt to a user of the device 10, indicating that relative movement between the device 10 and the object is needed for SAR sensing.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-20. (canceled)

21. A method of operation by a wireless communication device, the method comprising:
receiving a request for radar sensing;
responsive to the request, evaluating whether one or more conditions necessary for performing Synthetic Aperture Radar (SAR) sensing are satisfied, the one or more conditions including at least a motion condition;
responsive to the one or more conditions being satisfied, performing SAR sensing with respect to a physical environment containing the wireless communication device and correspondingly obtaining SAR sensing data; and
providing the SAR sensing data responsive to the request.

22. The method according to claim 21, wherein an Operating System (OS) function of the wireless communication device performs the method, wherein receiving the request comprises the OS function receiving the request from an application executing in an OS of the wireless communication device, via an Application Program Interface (API) provided by the OS, and wherein providing the SAR sensing data comprises outputting the SAR sensing data to the application via the API.

23. The method according to claim 21, wherein, responsive to any one of the one or more conditions not being satisfied, the method includes performing non-SAR sensing in response to the request, and correspondingly obtaining non-SAR sensing data and providing the non-SAR sensing data responsive to the request.

24. The method according to claim 21, wherein, responsive to any one of the one or more conditions not being satisfied, the method includes sending an indication towards a requestor that originated the request.

25. The method according to claim 21, wherein, in addition to the motion condition, the one or more conditions include a proximate object condition, and wherein the method comprises determining whether the proximate object condition is satisfied based on at least one of: acquiring one or more images from a camera of the wireless communication device and determining whether the one or more images indicate the presence of a proximate object; or acquiring non-SAR sensing data and determining whether the non-SAR sensing data indicates the presence of a proximate object.

26. The method according to claim 21, wherein determining whether the motion condition is satisfied comprises acquiring at successive times, non-SAR sensing data or camera images and determining whether a difference in estimated positions of a proximate object detected over the successively acquired non-SAR sensing data or camera images indicate relative movement between the object and the wireless communication device.

27. The method according to claim 26, further comprising, in a case where the successively acquired non-SAR sensing data or camera images indicate relative movement but where an Inertial Measurement Unit (IMU) of the wireless communication device indicates no translational or rotational motion of the wireless communication device, the method further comprises performing the SAR sensing as an Inverse SAR (ISAR) acquisition.

28. The method according to claim 26, further comprising, in a case where the successively acquired non-SAR sensing data or camera images indicate relative movement and where an Inertial Measurement Unit (IMU) of the wireless communication device indicates translational or rotational motion of the wireless communication device, the method further comprises performing the SAR sensing as a SAR acquisition.

29. The method according to claim 21, wherein the one or more conditions include a request condition, and wherein the method includes determining whether the request condition is satisfied by determining whether the request requests radar sensing at a resolution higher than that provided by non-SAR sensing.

30. The method according to claim 29, wherein, responsive to determining that the request does not request radar sensing at a resolution higher than that provided by non-SAR sensing, performing non-SAR sensing to acquire non-SAR sensing data and return the non-SAR sensing data responsive to the request.

31. A wireless communication device comprising:
radar circuitry configured for emission of radar signals and detection of corresponding reflection signals; and
processing circuitry configured to:
receive a request for radar sensing;
responsive to the request, evaluate whether one or more conditions necessary for performing Synthetic Aperture Radar (SAR) sensing are satisfied, the one or more conditions including at least a motion condition;
responsive to the one or more conditions being satisfied, perform SAR sensing with respect to a physical environment containing the wireless communication device and correspondingly obtain SAR sensing data; and
provide the SAR sensing data responsive to the request.

32. The wireless communication device according to claim 31, wherein the processing circuitry provides an Operating System (OS) function that is configured to receive the request from an application executing in an OS implemented via the processing circuitry, the request received via an Application Program Interface (API) provided by the OS, and wherein the OS function is configured to control the radar circuitry to obtain the SAR sensing data and output the SAR sensing data to the application via the API.

33. The wireless communication device according to claim 31, wherein the processing circuitry is configured to respond to any one or more of the conditions not being satisfied by performing non-SAR sensing in response to the request, and correspondingly obtaining non-SAR sensing data and providing the non-SAR sensing data responsive to the request.

34. The wireless communication device according to claim 31, wherein the processing circuitry is configured to send an indication towards a requestor that originated the request, responsive to any one of the one or more conditions not being satisfied.

35. The wireless communication device according to claim 31, wherein, in addition to the motion condition, the one or more conditions include a proximate object condition, and wherein the processing circuitry is configured to determine whether the proximate object condition is satisfied based on at least one of: acquiring one or more images from a camera of the wireless communication device and determining whether the one or more images indicate the presence of a proximate object; or acquiring non-SAR sensing data and determining whether the non-SAR sensing data indicates the presence of a proximate object.

36. The wireless communication device according to claim 31, wherein, to determine whether the motion condition is satisfied, the processing circuitry is configured to acquire at successive times, non-SAR sensing data or camera images and determine whether a difference in estimated positions of a proximate object detected over the successively acquired non-SAR sensing data or camera images indicate relative movement between the object and the wireless communication device.

37. The wireless communication device according to claim 36, wherein, in a case where the successively acquired non-SAR sensing data or camera images indicate relative movement but where an Inertial Measurement Unit (IMU) of the wireless communication device indicates no translational or rotational motion of the wireless communication device, the processing circuitry is configured to perform the SAR sensing as an Inverse SAR (ISAR) acquisition.

38. The wireless communication device according to claim 36, wherein, in a case where the successively acquired non-SAR sensing data or camera images indicate relative movement and where an Inertial Measurement Unit (IMU) of the wireless communication device indicates translational or rotational motion of the wireless communication device, the processing circuitry is configured to perform the SAR sensing as a SAR acquisition.

39. The wireless communication device according to claim 31, wherein the one or more conditions include a request condition, and wherein the processing circuitry is configured to determine whether the request condition is satisfied by determining whether the request requests radar sensing at a resolution higher than that provided by non-SAR sensing.

40. The wireless communication device according to claim 39, wherein the processing circuitry is configured to perform non-SAR sensing to acquire non-SAR sensing data and return the non-SAR sensing data responsive to the request, in response to determining that the request does not request radar sensing at a resolution higher than that provided by non-SAR sensing.
